(19) United States
(12) Patent Application Publication
(10) Pub. No.: US 2014/0287304 A1
(43) Pub. Date: Sep. 25, 2014

(54) ELECTRODE AND METHOD FOR MAUFACTURING THE SAME

(71) Applicant: Andreas NETZ, Ludwigsburg (DE)

(72) Inventor: Andreas NETZ, Ludwigsburg (DE)

(73) Assignee: Robert Bosch GmbH, Stuttgart (DE)

(21) Appl. No.: 14/217,785

(22) Filed: Mar. 18, 2014

(30) Foreign Application Priority Data
Mar. 20, 2013 (DE) 10 2013 204 872.6

(51) Int. Cl. H01M 4/13; H01M 4/139; H01M 4/04

(52) U.S. Cl. CPC H01M 4/13; H01M 4/0404; H01M 4/139
USPC 429/209; 427/58; 156/60

(57) ABSTRACT

An electrode for an electrochemical energy store, having at least two adjacently situated active material layers, the at least two active material layers having at least one active material and at least one conductive additive, the at least two active material layers furthermore having a gradient with respect to one another in terms of the active material concentration, the at least two active material layers furthermore having a gradient with respect to one another in terms of the conductive additive concentration, and the gradient in terms of the active material concentration and the gradient in terms of the conductive additive concentration being developed to run in opposite directions. An electrode of this kind also allows for a good high-current capability and a good storage capacity. Also described is a method for manufacturing an electrode of this kind.

### RELATED APPLICATION INFORMATION

The present application claims priority to and the benefit of German patent application no. 10 2013 204 872.6, which was filed in Germany on Mar. 20, 2013, the disclosure of which is incorporated herein by reference.

### FIELD OF THE INVENTION

The present invention relates to an electrode. The present invention further relates to a method for manufacturing an electrode.

### BACKGROUND INFORMATION

Energy stores such as lithium-ion batteries, for example, are widely used in many everyday applications. They are used for example in computers, for example laptops, in mobile telephones, smart phones and in other applications. Batteries of this kind also offer advantages in the currently highly promoted electrification of vehicles such as motor vehicles for example.

Depending on the field of application, different requirements of the energy store should be met. If current is required quickly for example, then the cells of the energy store must be optimized for performance. On the other hand, if current is required over a long time period, then the cells are optimized for energy density, that is, with respect to the quantity of storable energy. The electrodes must be configured for such applications. Electrodes optimized for different applications, differ in their configuration. Fundamentally, however, it may be advantageous if both a quick provision of energy is possible as well as a high storage density, which can be difficult to achieve, however, through opposed configurations or opposed optimization variants.

### SUMMARY OF THE INVENTION

The subject matter of the present invention is an electrode for an electrochemical energy store, having at least two adjacently situated active material layers, the at least two active material layers having at least one active material and at least one conductive additive, the at least two active material layers furthermore having a gradient with respect to each other in terms of the active material concentration, the at least two active material layers furthermore having a gradient with respect to each other in terms of the conductive additive concentration, and the gradient in terms of the active material concentration and the gradient in terms of the conductive additive concentration being developed to run in opposite directions.

An electrochemical energy store in the sense of the present invention may include in particular any battery. In particular, apart from a primary battery, an energy store may include especially a secondary battery, that is, a rechargeable accumulator. A battery in this context may include or be a galvanic element or a plurality of interconnected galvanic elements. For example, an energy store may include a lithium-based energy store such as a lithium-ion battery for example. In this context, a lithium-based energy store such as a lithium-ion battery for example may be understood in particular as an energy store whose electrochemical processes during a charging or discharging process are based at least partially on lithium ions.

In the sense of the present invention, an active material layer may furthermore be understood as a layer, in which the active material, that is, in particular the material participating in or used in a charging process or discharging process, is located. The active material layer fundamentally includes, in addition to the active material as such, a suitable conductive additive such as soot, for example, and a suitable binder such as polyvinylidene fluoride (PVDE) for example.

A gradient may furthermore be understood as a mutually deviating concentration or quantity, that is, in particular a concentration gradient existing between different layers. The concentration of active material, which is also called loading, may be indicated in the sense of the present invention in particular as mAh/cm² at a constant electrode layer height (e.g. 80 μm) or more specifically with reference to the volume as mAh/cm³. A gradient could be formed for example if in one electrode layer a high concentration of active material is set of 3.5 mAh/cm² for example, while in another electrode layer, by contrast, a lower concentration of e.g. 1.5 mAh/cm² is set, having at the same time a higher electronic conductivity. Furthermore, a gradient may be indicated by way of example in % parts by weight or in % by weight.

An electrode as described above makes it possible to combine a high current capacity, that is, a quick discharge or current delivery and a quick recharge of cells with an at the same time high storage capacity for electrical charge, over a long time period, for example in the sense of a long life of battery cells and/or of a discharge cycle.

For this purpose, the electrode has at least two adjacently situated active material layers. The active material layers in this instance may be directly adjacent to each other and thus be in contact with or touch each other. Alternatively, the active material layers may be indirectly adjacent, it being possible for another layer to be situated between the active material layers.

The active material layers include in the first place an active material. The active material layers may in particular have the same active material. For the exemplary and non-limiting case that the electrode is an anode, graphite may be provided as the active material for example. Furthermore, if the electrode is a cathode, other lithium compounds such as lithium nickel cobalt manganese oxide (NCM) or lithium manganese oxide (LMO) for example may be provided as the active material. Other active materials are e.g. lithium titanate (LTO) and lithium iron phosphate (LFP). Generally, all compounds capable of entering a reversible reaction with lithium are suitable.

Furthermore, a conductive additive is provided in the active material layers. For example and in non-limiting fashion, soot may be used as conductive additive.

To achieve a suitable stability of the active material layer, the active material and the conductive additive are situated in a suitable binder. The binder may likewise be any binder known from the related art. For example and in non-limiting fashion, polyvinyllidene fluoride may be used as conductive additive.

In an electrode as described above, there is furthermore a provision for the at least two active material layers to have a gradient in terms of the active material concentration. The two active material layers thus have a different concentration of the active material. When providing more than two active material layers, which may be in particular situated adjacently to each other and which may likewise advantageously all have the same active material, a continuous reduction or, respectively, increase of the concentration of the active material is furthermore provided in the individual active material layers.

There is furthermore a provision for the at least two active material layers to have a gradient in terms of the conductive additive concentration. The two active material layers thus have a different concentration of the conductive additive. When providing more than two active material layers, which may be in particular situated adjacently to each other and which may likewise advantageously all have the same conductive additive, a continuous reduction or, respectively, increase of the concentration of the conductive additive is furthermore provided in the individual active material layers.

In an electrode as described above, the gradients of the active material and of the conductive additive are coupled to each other in such a way that the gradient in terms of the active material concentration and the gradient in terms of the conductive additive concentration are oppositely directed. In other words, the concentration of the active material decreases in one direction along the layer sequence of the active material layers, as the concentration of the conductive additive increases in the same direction along the layer sequence of the active material layers. Selected layers in this instance have a gradient with respect to each other, and thus have different concentrations of the active material and the conductive additive, respectively, or there may be a continuous gradient, which in in the sense of the present invention in particular may mean that all layers have a successively decreasing and, respectively, increasing concentration of the active material and, respectively, of the conductive additive with respect to each other, or vice versa.

This development is able to produce numerous advantages of the electrode structure described above. In particular, different requirements such as for example a high current capacity and the provision of a high energy density may be achieved within one electrode or one cell. A varying and partly oppositely directed optimization of the electrode for different requirements is no longer necessary according to the present invention, which means that the electrodes or the energy stores equipped with the electrodes are not adapted to or optimized for only one requirement, but rather a plurality of requirements may be met equally. This results in a particularly broad diversity of applications and thus allows many different types of electrical devices to be equipped with one type of energy store.

In detail, an electrode of this kind has active material layers, which have a low concentration of active material and a high concentration of conductive additive. Due to a low inner resistance due to a quick transport of electrons and ions, active material layers of this kind may be used in particular to make possible a particularly quick lithium ion exchange and hence a high current capacity or a particularly quick charging process and discharging process, since these have a particularly good electrical conductivity. Furthermore, there are active material layers that have a particularly high concentration of active material and a comparatively low concentration of conductive additive. Such layers are particularly able to store electrical energy, for example in the form of lithium ions. The electrode or the layer structure of the electrode thus has different active material layers, which are embodied differently and are respectively suited for different applications.

In connection with one development, one of the at least two layers may be situated adjacently to a current collector in such a way that the active material layer situated adjacent to the current collector has the highest active material concentration and the lowest conductive additive concentration. In other words, a layer sequence having at least two active material layers may be situated on a current collector, one active material layer being situated adjacent to the current collector, contacting the latter directly for example. In this instance, the layer situated next to the current collector, in particular the layer directly contacting the current collector, may have the highest concentration of active material and the comparatively lowest concentration of conductive additive. Accordingly, the layer most distant from the current collector may have the highest concentration of conductive additive and the comparatively lowest concentration of active material.

This development in particular advantageously makes it possible for the electrode to be able to take up lithium ions particularly quickly by its active material layer furthest removed from the current collector, which then may contact in particular a complementary electrode or a separator, for the exemplary case that the electrode is a component of the lithium ion accumulator, the lithium ions then gradually diffusing through the layer structure in the direction of the current collector. In particular the layer situated adjacent to the current collector, particularly the layer directly contacting the current collector, may be used for the actual storage of the energy and thus of the lithium ions. This functional principle is independent of the number of layers, although a plurality of layers may be advantageous as a function of application. In this development in particular, a high current capacity may be combined especially effectively and markedly with a high storage capacity for electrical energy.

In connection with another development, a gradient may be provided in terms of the thickness of the active material layers, the gradient of the thickness of the active material layers being directed in accordance with the gradient of the concentration of the active material. This development in particular is able to exploit the fact that the active material layer having a high concentration of active material may be used to store electrical energy. Due to the fact that these layers of a high active material concentration in this development have comparatively large thickness, these layers thus have a particularly large quantity of active material. Particularly in this development, the storage capacity of such an electrode may therefore be especially large. In the sense of the present invention, however, directing the gradient of the thickness of the active material layers in accordance with the gradient of the concentration of the active material may mean in particular that in particular a layer having a low concentration of active material has a lesser thickness than an active material layer having a comparatively high concentration of active material. It is possible that only selective active material layers vary in terms of their thickness, or there may be a continuous gradient in terms of the layer thicknesses, that is, a gradient that forms along all active material layers. Suitable thicknesses are for example in a range from greater than or equal to 2 μm to smaller than or equal to 50 μm for a comparatively thin layer thickness and in a range from greater than or equal to 50 μm to smaller than or equal to 100 μm for a comparatively large layer thickness, it being possible for the gradient in terms of the thickness of the active material layers to lie in a range from great than or equal to 0.5 mAh/cm² to smaller than or equal to 5 mAh/cm².

In connection with another development, the gradient of the active material concentration may be in a range from greater than or equal to 5% by weight to less than or equal to 95% by weight. This development in particular advantageously allows for example for layers contacting a separator or a complementary electrode to be advantageously suitable for quick power input and power output. The layers situated in close proximity to a current collector, however, may be particularly well suited for charge storage. For example, the concentration of the active material in the layer having the smallest concentrations may be in a range from greater than or equal to 5% by weight to less than or equal to 90% by weight, whereas the concentration of the active material in the active material layer having the highest concentration may be in a range from greater than or equal to 50% to less than 100% by weight.

In connection with another development, the gradient of the active material concentration may be in a range from greater than or equal to 5% by weight to less than or equal to 95% by weight. This development in particular advantageously allows for example for the outer layers to be advantageously suitable for quick power input and power output. The additional layers, however, may be particularly well suited for charge storage.

For example, the concentration of the conductive additive in the layer having the lowest concentrations may be in a range from greater than 0% by weight to less than or equal to 10% by weight, whereas the concentration of the conductive additive in the active material layer having the highest concentration may be in a range from greater than or equal to 2% to less than 80% by weight.

Regarding additional advantages and features, explicit reference is hereby made to the explanations in connection with the method of the present invention and the figures. Features and advantages of the method of the present invention are also to be considered applicable to the electrode of the present invention and count as disclosed, and vice versa. The present invention also includes all combinations of at least two of the features disclosed in the specification, in the claims and/or in the figures.

The subject matter of the present invention is furthermore a method for manufacturing an electrode, in particular an electrode developed as described above, having the method steps:
a) Providing a current collector;
b) Applying a first active material layer on the current collector, the first active material layer having an active material and a conductive additive; and
c) Applying at least one second active material layer on the first active material layer, the second active material layer having an active material and a conductive additive;
d) the two active material layers having a gradient with respect to each other in terms of the active material concentration, the at least two active material layers furthermore having a gradient with respect to each other in terms of the conductive additive concentration, and the gradient in terms of the active material concentration and the gradient in terms of the conductive additive concentration being oppositely directed.

A method of this kind is suited in a particularly advantageous manner to manufacture an electrode developed as described above and thus to create an electrode that is equally suitable for the most diverse requirements such as in particular a high current capacity in combination with a good storage capacity for electrical power.

For this purpose, the method includes in a first method step a) the provision of a current collector, which is able to act equally as a current tap for tapping electrical energy or is able to be connected to such a current tap. The current collector fundamentally may be developed as known from the related art. The current collector is for example made from a metal and developed in a foil-like manner. If an anode is being manufactured, the current collector may be developed from copper, whereas the current collector may be made from aluminum if a cathode is to be manufactured.

According to method step b), a first active material layer is applied on the current collector. In this instance, the first active material layer includes an active material and a conductive additive. For the exemplary and non-limiting case that the electrode is an anode, graphite may be provided as the active material for example. Furthermore, if the electrode is a cathode, a lithium salt such as lithium nickel cobalt manganese oxide (NCM) or lithium manganese oxide (LMO) for example may be provided as the active material. Soot may be used as the conductive additive for example. Furthermore, the active material layer may have a binder such as polyvinyllidene fluoride.

In another method step c), a second active material is then applied onto the first active material layer, the second active material layer likewise including an active material, a conductive additive and, if applicable, a binder. The type of active material, conductive additive and binder may correspond to the respective components in the first active material layer. The second active material layer may be applied directly and immediately onto the first active material layer, or indirectly, by providing additional intermediate layers. The second active material layer is furthermore chosen in such a way that the at least two active material layers have a gradient with respect to each other in terms of the active material concentration, and that the at least two active material layers furthermore have gradient with respect to each other in terms of the conductive additive concentration, the gradient in terms of the active material concentration and the gradient in terms of the conductive additive concentration being oppositely directed.

Additional active material layers may be applied as well, which are configured so as to correspond to the gradients described above.

In connection with one development, the application of the active material layers may be performed in a laminating process. Laminating the layers in particular makes it possible to bond layers having defined layer thicknesses, a particularly firm bond being furthermore achievable in this manner. A particularly sturdy formation for the electrode may thus be obtained in this development, even if the layer thicknesses are very small. Lamination is moreover a very mature and cost-effective method. A lamination may be performed in that the individual layers are guided through a roller press or are pressed in a press. Pressing may be performed in particular by heating the layers so as to soften an existing binder in order to achieve an adhesion or a firm bond between the layers.

In connection with another development, the active material layers may be provided by dry coating or by wet coating.

In exemplary and non-limiting fashion, dry coating may be performed as follows. The active material is premixed with the binder and the conductive additive. This mixture is converted via heated calender rolls into a free-standing electrode film. The free-standing film may be joined via heated calender rolls to other electrode films produced according to this method.

The joined films are finally applied to a current collector or an arrester foil.

In exemplary and non-limiting fashion, wet coating may be performed as follows. The active material is dispersed together with the binder and the conductive additive in a solvent (e.g. water or NMP). The binder is normally dissolved in the utilized solvent. The dispersion (slurry) is applied onto the arrester foil using a casting process (e.g. blade or slot nozzle). The wet film still wet with solvent is dried using air-convention ovens or by infrared. In the process, the binder forms a network by the evaporation of the solvent, which allows for the active material and the conductive additive to adhere on the arrester foil. Another electrode layer may now be applied on this dry electrode film according to the same method.

In this development in particular, the active material layers may be provided as independent layers and be bonded with the additional layers, for example laminated. The precise development of the layers, particularly with respect to concentrations of the active material or with respect to the conductive additive concentration may be adjustable in a particularly simple manner. In the case of dry coating, the active material layer may be produced directly, whereas in wet coating the layer is deposited, for example using a blade or a slot nozzle, first on a carrier such as Mylar film, for example, and is subsequently separated from the carrier.

In the context of another development, the current collector may be pretreated for improving the adhesion of the active material layer, that is, it may be so treated prior to the application of the active material layer. Various methods of pretreatment are possible in this regard such as increasing the surface by mechanically roughening and/or patterning, for example by brushing, laser patterning or embossing. Furthermore, a pretreatment step prior to the application of the active material layer may include chemical roughening by flash-etching or electroplating.

Regarding additional advantages and features, explicit reference is hereby made to the explanations in connection with the electrode of the present invention and the figures. Features and advantages of the method of the present invention are also to be considered applicable to the electrode of the present invention and count as disclosed, and vice versa. The present invention also includes all combinations of at least two of the features disclosed in the specification, in the claims and/or in the figure.

Further advantages and advantageous refinements of the subject matters of the present invention are illustrated by the drawing and explained in the following description. In this context, it should be noted that the drawing has only a descriptive character and is not intended to limit the present invention in any form.

### BRIEF DESCRIPTION OF THE DRAWING

FIG. 1 shows a schematic representation of an electrode according to the present invention.

### DETAILED DESCRIPTION

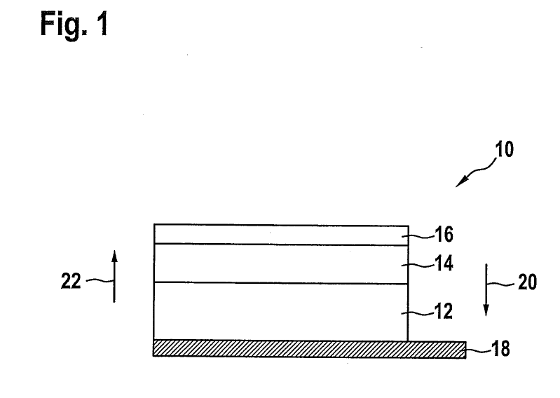

FIG. 1 shows a development of an electrode 10. Such an electrode 10 may be used in an energy store for example such as a lithium-ion battery in particular. For example, the energy store equipped with the represented electrode 10 may be used in electrically driven vehicles, in computers such as laptops, mobile telephones, smart phones, power tools and other applications such as for example completely electrically driven vehicles (EV) or partly electrically driven vehicles (hybrid vehicles, PHEV).

An electrode 10 of this kind includes at least two, three in the development shown in FIG. 1, adjacently situated active material layers 12, 14, 16, The active material layers 12, 14, 16 in this instance have at least one active material. Regarding the concentrations of the active material in the active material layers, there exists a gradient of the active material concentration. Active material layers 12, 14, 16 furthermore include a conductive additive, active material layers 12, 14, 16 furthermore having a gradient with respect to the conductive additive concentration. There is a provision for the gradient with respect to the active material concentration and the gradient with respect to the conductive additive concentration to be developed oppositely directed with respect to each other.

For example, the gradient of the active material concentration may be in a range from greater than or equal to 5% by weight to less than or equal to 95% by weight, and the gradient of the conductive additive concentration may be in a range of greater than or equal to 1% by weight to less than or equal to 50% by weight.

Advantageously, one 12 of the active material layers 12, 14, 16 may be situated adjacently to a current collector 18 in such a way that the active material layer 12 situated adjacent to current collector 18 has the highest active material concentration and the lowest conductive additive concentration. This is shown by the gradient-describing arrows 20 for the gradient of the active material concentration and arrow 22 for the conductive additive concentration. For this purpose, particularly the active material layer situated adjacent to current collector 18 may have a suitable binder so as to effect good adhesion of active material layer 12 to current collector 18.

The development of FIG. 1 furthermore provides for a gradient with respect to the thickness of active material layers 12, 14, 16, the gradient of the thickness of active material layers 12, 14, 16 being directed in accordance with the gradient of the concentration of the active material, represented by arrow 20.

A method for manufacturing an electrode 10 of this kind may include the method steps:
a) Providing a current collector 18;
b) Applying a first active material layer 12 on current collector 18, the first active material layer 12 having an active material and a conductive additive; and
c) Applying at least one second active material layer 14 on the first active material layer 12, the second active material layer 14 having an active material and a conductive additive;
d) the two active material layers 12, 14, 16 having a gradient with respect to the active material concentration, the at least two active material layers 12, 14, 16 furthermore having a gradient with respect to the conductive additive concentration, and the gradient of the active material concentration and the gradient of the conductive additive concentration being oppositely directed with respect to each other.

For this purpose, method steps b) and c) may occur in succession or simultaneously. In the latter case in particular and by way of example, active material layers 12, 14, 16 may be applied by a laminating process. Furthermore, active material layers 12, 14, 16 may be provided as independent components by dry coating or by wet coating.

What is claimed is:

1. An electrode for an electrochemical energy store, comprising:
at least two adjacently situated active material layers, the at least two active material layers having at least one active material and at least one conductive additive, the at least two active material layers further having a gradient with respect to each other in terms of the active material concentration, the at least two active material layers further having a gradient with respect to each other in terms of the conductive additive concentration, and the gradient in terms of the active material concentration and the gradient in terms of the conductive additive concentration being configured to run in opposite directions.

2. The electrode of claim 1, wherein one of the at least two layers is situatable adjacently to a current collector so that the active material layer situated adjacent to current collector has the highest active material concentration and the lowest conductive additive concentration.

3. The electrode of claim 1, wherein a gradient with respect to the thickness of the active material layers is provided, the gradient of the thickness of active material layers being directed in accordance with the gradient of the concentration of the active material.

4. The electrode of claim 1, wherein the gradient of the active material concentration is in a range from greater than or equal to 5% by weight to less than or equal to 95% by weight.

5. The electrode of claim 1, wherein the gradient of the conductive additive concentration is in a range from greater than or equal to 1% by weight to less than or equal to 50% by weight.

6. A method for manufacturing an electrode, the method comprising:
providing a current collector;
applying a first active material layer on a current collector, the first active material layer having an active material and a conductive additive; and
applying at least one second active material layer on the first active material layer, the second active material layer having an active material and a conductive additive;
wherein the at least two active material layers have with respect to one another a gradient with respect to the active material concentration, wherein the at least two active material layers have with respect to one another a gradient with respect to the conductive additive concentration, and wherein the gradient of the active material concentration and the gradient of the conductive additive concentration are oppositely directed with respect to each other.

7. The method of claim 6, wherein the application of the active material layers occurs by a laminating process.

8. The method of claim 6, wherein the active material layers are provided by a dry coating or a wet coating.

9. The method of claim 6, wherein the current collector is pretreated to improve the adhesion of the active material layer.
